(19) United States
(12) Patent Application Publication
(10) Pub. No.: US 2016/0214839 A1
(43) Pub. Date: Jul. 28, 2016

(54) Portable Electronic Vehicle Lift

(71) Applicant: Rene Boudreau, Brooksville, FL (US)

(72) Inventor: Rene Boudreau, Brooksville, FL (US)

(21) Appl. No.: 15/002,636

(22) Filed: Jan. 21, 2016

Related U.S. Application Data
(60) Provisional application No. 62/106,847, filed on Jan. 23, 2015.

(51) Int. Cl. B66F 3/25; B66F 3/42; B66F 3/24

(52) U.S. Cl. CPC B66F 3/25; B66F 3/24; B66F 3/42

(57) ABSTRACT

A portable electronic vehicle jack is provided. The present invention provides a vehicle lifting device including a telescoping hydraulic cylinder disposed inside a portable housing, wherein a piston is extendable and retractable therefrom. The piston includes an engaging member configured to engage a vehicle and sustain the load. An electrically driven hydraulic pump is operably connected to the hydraulic cylinder and includes a reservoir having a hydraulic fluid therein. The hydraulic pump is configured to displace the hydraulic fluid into and out of an expandable chamber within the hydraulic cylinder. Displacement of the hydraulic fluid into the expandable chamber exerts an upward force onto the piston, which drives the piston upwards along a vertical axis. A remote control having one or more switches is provided for activating the electrical drive of the hydraulic pump and displacing the hydraulic fluid to either extend or retract the piston.

### CROSS REFERENCE TO RELATED APPLICATIONS

This application claims the benefit of U.S. Provisional Application No. 62/106,847 filed on Jan. 23, 2015. The above identified patent application is herein incorporated by reference in its entirety to provide continuity of disclosure.

### BACKGROUND OF THE INVENTION

The present invention relates to vehicle lift systems. Specifically, the present invention relates to an electronic vehicle jack having a hydraulic system, wherein a telescoping hydraulic cylinder is operable by an electrically driven hydraulic pump configured to displace a hydraulic fluid into and out of the hydraulic cylinder by operation of a remote control to either extend or retract a piston therein.

Vehicle lifts, such as scissor jacks and bottle jacks, are known for their ability to raise the chassis of a vehicle and as such are commonly used by many mechanics and individuals to fix automobiles needing repairs and/or maintenance. One common repair in which a jack is invariably employed is in fixing or changing a flat or damaged tire. This is because when fixing a tire, the chassis of the vehicle adjacent to the tire must be raised, thereby taking the weight off of the tire and enabling a person to remove the malfunctioning or damaged tire.

Unfortunately, however, jacks are often bulky, difficult to transport, and require manual operation. These drawbacks can be particularly onerous because as a result, drivers are commonly stuck without a vehicle jack or have to manually operate their jack when getting a flat tire while in transit. Because such a defect usually gives rise to an immediate need to change the tire, this creates a potentially hazardous condition for drivers getting a flat tire while in transit as highways can be very dangerous due to traffic and weather conditions. Furthermore, many drivers may not have the knowledge or physical strength to operate and/or manually raise or lower a vehicle with a manual jack in order to change a flat tire. Therefore, there is a need in the prior art for a portable electronic vehicle jack that is adapted to raise a vehicle with the press of a button and further adapted to be stowable within a housing such that the jack may be easily transported in a vehicle.

Scissor jacks are referred to as mechanical jacks in that they utilize mechanical power by employing a horizontally oriented screw thread to create a vertical force. Turning of the screw creates a rotational motion which translates to either an upward force to lift a vehicle or a downward force to lower a vehicle. Scissor jacks are collapsible in nature and are typically more lightweight than other jacks, however, they have smaller lifting capacities and lift vehicles less as compared to floor jacks.

Floor jacks utilize hydraulic power or liquid fluid power, which involves the movement of an almost incompressible fluid, such as oil, from a first reservoir to a second reservoir within a hydraulic cylinder. The movement of the liquid into the reservoir of the hydraulic cylinder displaces a piston therein, causing a strong upward force, thereby driving the jack. This hydraulic system utilizes a pump to drive oil from the first reservoir into the second reservoir via one or more valves. In floor jacks, this pump action is created by a manual crank which is connected to a piston in the first reservoir. Cranking displaces this piston which pumps the fluid from the first reservoir into the second reservoir in the hydraulic cylinder. Displacement of the hydraulic fluid into the second reservoir exerts and upward force onto the piston therein, which is then lifted vertically, thereby driving the jack. Floor jacks have larger lifting capacities than screw jacks and can also lift a vehicle higher. However, they are typically heavy, require manual operation, and are difficult to transport. Therefore, there is a need in the prior art for a vehicle lift comprising a portable hydraulic system that utilizes an electrically driven pump to displace the hydraulic fluid into a hydraulic cylinder, such that it may be remotely operated.

Devices have been disclosed in the prior art that relate to electronic vehicle lifts. These include vehicle lifts that have been patented and published in patent application publications. These devices generally relate to vehicle lifts comprising electrically driven scissor jacks. The following is a list of devices deemed most relevant to the present disclosure, which are herein described for the purposes of highlighting and differentiating the unique aspects of the present invention, and further highlighting the drawbacks existing in the prior art.

U.S. Pat. No. 7,472,889 to Prather discloses an electrically driven vehicle lift system providing a lifting device similar to a mechanical jack in so far as the lift system includes a piston driven by a screw thread therein. The screw thread is coupled to a gear assembly that is coupled to a drive shaft that is coupled to a motor. In use, the motor is electrically actuated to rotate the drive shaft in a first direction or a second direction, which drives the gear assembly, which then drives the screw thread and the piston. Although, the lift system of Prather is similar in nature and relevant to the present invention, it differs in that it fails to provide a hydraulic lift system powered by hydraulic power or liquid fluid power.

U.S. Pat. No. 7,988,131 to Carder discloses an electric scissor jack apparatus which is driven by a high torque electric motor. The electric scissor jack is a mechanical jack in so far as the jack is driven by a screw drive or jackscrew. Although, the electric scissor jack of Carder is similar in nature and relevant to the present invention, it, too, differs in that it fails to provide a hydraulic lift system powered by hydraulic power or liquid fluid power.

U.S. Pat. No. 6,910,677 to Miller discloses a portable scissor jack which utilizes a worm screw as the jack's operational mechanism to lift a lift plate and raise a vehicle. The portable scissor jack is a mechanical jack in so far as it utilizes an operational mechanism utilizing a screw. Although, the portable scissor jack of Miller is similar in nature and relevant to the present invention, it, too, differs in that it fails to provide a hydraulic lift system powered by hydraulic power or liquid fluid power.

U.S. Pat. No. 6,877,200 to Villarreal discloses an electrically operated apparatus for vehicle tire repair or replacement having a pneumatic jack or a hydraulic jack that is driven by an air compressor. The apparatus discloses a hydraulic jack within a housing operably connected to an air compressor. Operation of the jack, however, is provided by the air flow supplied by the air compressor. The device teaches a hydraulic jack having a hydraulic fluid therein, which in use, would drive the jack shaft upwards upon pressure being exerted on it by air flow from the compressor. Although, the apparatus of Villarreal is similar in nature and relevant to the present invention, it differs in that it fails to provide a hydraulic lift system having an electrically driven pump configured to displace hydraulic fluid from a reservoir therein to the hydraulic jack, thereby displacing same.

Finally, U.S. Pat. No. 3,844,535 to Dorough discloses an electric automobile jack having a rotatable lift shaft which is driven by the operation of an electric motor. In use, actuation of the electric motor drives a drive shaft, which in turn drives a gear shaft, which in turn drives a lift shaft. The electric automobile jack is a mechanical jack in so far as it employs a screw like lift shaft that lifts a vehicle. Although, the electric automobile jack of Dorough is similar in nature and relevant to the present invention, it differs in that it fails to provide a hydraulic lift system powered by hydraulic power or liquid fluid power.

The present invention provides a portable electronic vehicle lift utilizing a hydraulic lift system to raise and lower the chassis of a vehicle. The tool includes a portable housing having a hydraulic cylinder operably connected to a hydraulic pump therein. The pump includes a reservoir and the hydraulic cylinder comprises an expandable chamber wherein the reservoir and chamber are operably connected by a coupling valve. Electrical operation of the hydraulic pump by a remote control drives a hydraulic fluid in the pump's reservoir to the hydraulic cylinder's chamber, thereby creating an upward force that drives a piston within hydraulic cylinder. The portable electronic vehicle lift is distinguished from the prior art because the device incorporates an electrically driven hydraulic pump that displaces a hydraulic fluid therein which in turn creates a upward force in the hydraulic cylinder that drives the piston along a vertical axis to lift a vehicle. By incorporating a hydraulic system into one portable housing that includes an electrically driven hydraulic pump, the vehicle jack may provide a portable jack that supports a heavier weight and lifts larger vehicles while being remotely operable.

In view of the drawbacks of the prior art devices, it is shown that the prior art has several known setbacks and that the present invention is substantially divergent in design elements from the prior art and subsequently it is clear that there is a need in the art for an improvement to electronic vehicle lifts. In this regard, the instant invention substantially fulfills these needs.

### SUMMARY OF THE INVENTION

In view of the foregoing disadvantages inherent in the known types of vehicle lift systems now present in the prior art, the present invention provides a portable electronic vehicle jack wherein the same can be utilized for providing convenience for the user when lifting a vehicle to repair an impaired or malfunctioning tire thereon. The present system provides an apparatus comprising a housing. The housing contains a hydraulic cylinder having a piston therein, which is vertically orientated such that it can extend and retract along a vertical axis. The hydraulic cylinder is defined by a base tube having an expandable chamber, wherein the piston is slidably disposed. The piston comprises an engaging member for engaging and sustaining the weight of a vehicle thereon. The piston is configured to extend and retract from the housing through an opening of the housing's upper wall. Further, the housing comprises an electrically driven hydraulic pump, which is operably coupled to the hydraulic cylinder via a coupling valve. The hydraulic pump comprises a reservoir of hydraulic fluid, such as an incompressible fluid, configured to transfer to an expandable chamber within the hydraulic cylinder via the valve coupler. The hydraulic pump is configured to displace the hydraulic fluid into and out of the expandable chamber. Displacement of the hydraulic fluid from the hydraulic pump into the hydraulic cylinder's expandable chamber exerts a strong upward force onto the piston therein, thereby driving the piston vertically out of the housing such that it may lift a vehicle and the engaging member may sustain the load of the vehicle. Displacement of the hydraulic fluid from the expandable chamber into the hydraulic pump's reservoir reduces the upward force exerted on the piston, which in turn retracts the piston vertically into the housing such that the engaging member may be stowed inside the housing. A remote control is operably connected to the hydraulic pump and comprises one or more switches configured to activate the hydraulic pump and displace the hydraulic fluid either into or out of the expandable chamber. The remote control contains an electric cable that includes a connector configured to connect to a vehicle's power supply port for powering the hydraulic pump.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side phantom view of the portable electronic vehicle jack in a stowed configuration according to one embodiment of the present invention.

FIG. 2 shows a perspective phantom view of the portable electronic vehicle jack in an extended configuration according to one embodiment of the present invention.

FIG. 3 shows a side partial cross-sectional view of the hydraulic cylinder and hydraulic pump of the portable electronic vehicle jack according to one embodiment of the present invention.

FIG. 4 shows a perspective view of the remote control and connector of the portable electronic vehicle jack according to one embodiment of the present invention.

FIG. 5 shows a perspective view of the portable electronic vehicle jack in use according to one embodiment of the present invention.

### DETAILED DESCRIPTION OF THE INVENTION

Reference is made herein to the attached drawings. Like reference numerals are used throughout the drawings to depict like or similar elements of the electronic vehicle lift. The figures are intended for representative purposes only and should not be considered to be limiting in any respect.

The electronic vehicle jack is configured to be a portable hydraulic lift system adapted to engage and lift the portion of the chassis of a vehicle adjacent to a front tire or adjacent to a rear tire thereof. Preferably, the jack is adapted to lift said portions of the vehicle vertically off of the ground when inspecting the undercarriage of a vehicle proximate to those portions, replacing an impaired or malfunctioning tire corresponding to those portions, and/or engaging in mechanical work or repairs to a vehicle underneath the area proximate to those portions.

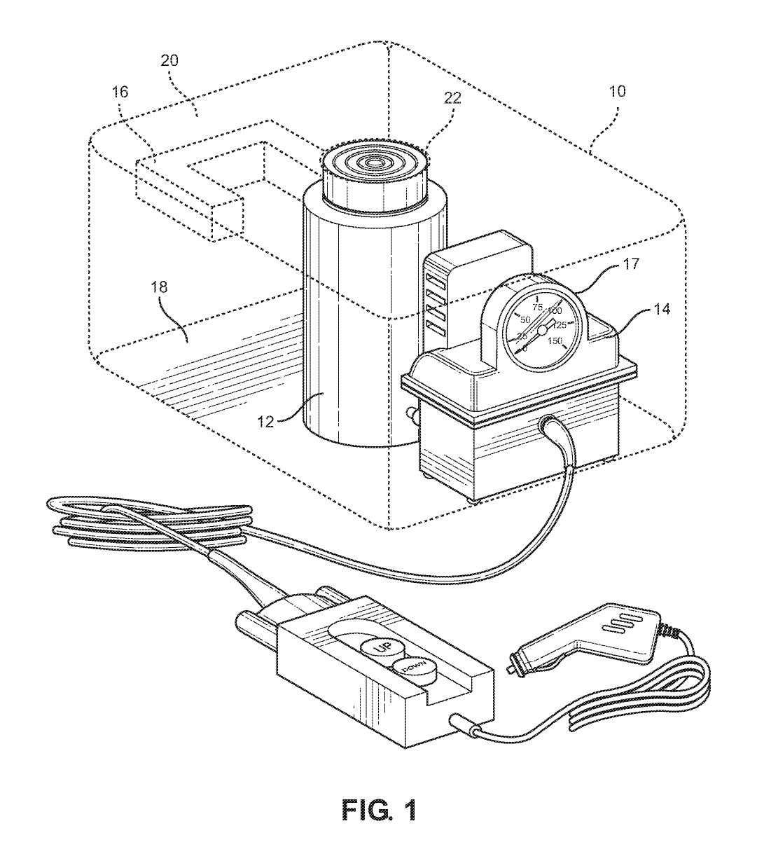

Referring now to FIG. 1, there is shown a perspective phantom view of the electronic vehicle jack in a stowed configuration according to one embodiment of the present invention. The electronic vehicle jack comprises a housing 10 having an interior volume formed by a lower wall 18, side walls, and an upper wall 20. The interior volume comprises a stowable hydraulic cylinder 12 and an electrically driven hydraulic pump 14, wherein the hydraulic cylinder 12 and the hydraulic pump 14 are operably coupled. In the depicted embodiment, the hydraulic cylinder 12 is shown retracted in its stowed configuration. One of the side walls of the housing 10 includes a handle 16 on the exterior surface thereof for carrying and/or transporting the electronic vehicle jack. The lower wall 18 acts as a support base for the hydraulic cylinder 12 and the hydraulic pump 14. The upper wall 20 comprises a first opening 22 through which the hydraulic cylinder 12 is adapted to extend and retract. In the depicted embodiment, the housing 10 comprises four side walls forming a box-shape, wherein a handle 16 is disposed on a back wall and wherein a pressure gauge 17 is displayed on a front wall. In one embodiment, the handle 16 is hingedly connected to a wall of the housing. In a second embodiment, the housing 10 further comprises a second opening on a front wall that corresponds to the pressure gauge 17 of the hydraulic pump 14, such that the pressure gauge 17 rests flush to the second opening. The housing 10 may be composed of a durable, plastic material, such as polyvinyl chloride or polycarbonate, or a durable lightweight metal, such as titanium or aluminum.

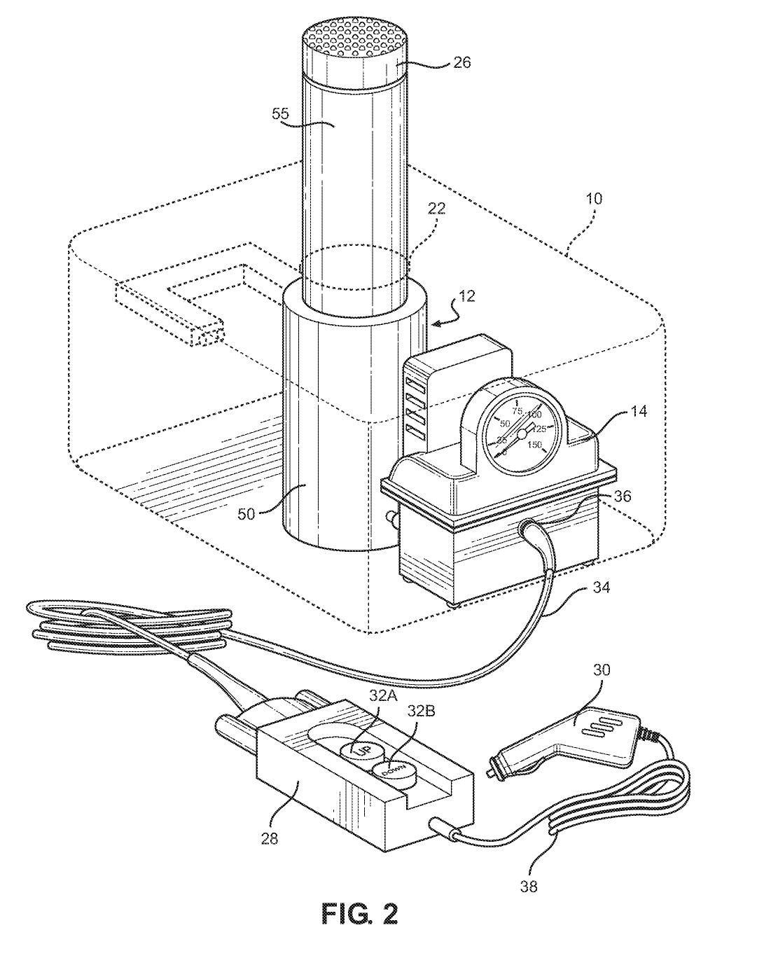

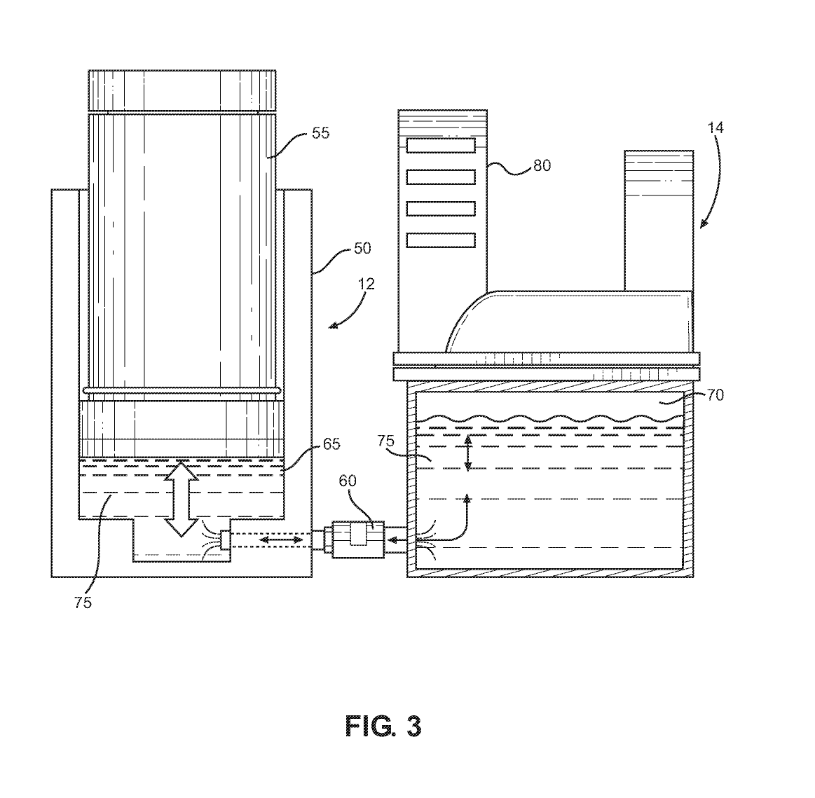

Referring now to FIGS. 2 and 3, there is shown a perspective phantom side view and a side partial cross-sectional view of the hydraulic cylinder and hydraulic pump of the portable electronic vehicle jack according to one embodiment of the present invention. The hydraulic cylinder 12 is configured to move from a stowed configuration along a vertical axis into an extended configuration and vice versa. The hydraulic cylinder 12 is defined by a base tube 50 having an expandable chamber wherein a piston 55 is slidably disposed. The piston 55 is slidably disposed within the base tube 50 such that it forms a telescopic arrangement in which it can vertically extend and retract from the base tube 50. The piston 55 comprises an engaging member 26 at the distal end thereof. The engaging member 26 is configured to receive the chassis of a vehicle and sustain the load thereon.

When the piston 55 is extended from the base tube 50, the engaging member 26 is raised until it makes contact with the chassis of a vehicle. The upward force exerted by the engaging member 26 onto the chassis of the vehicle lifts the vehicle vertically off of the ground. In the depicted embodiment, the engaging member 26 comprises a planar circular platform composed of a durable, rubber material for gripping the load thereon and for being less destructive to the paint or frame of a vehicle being lifted thereby. Preferably, the diameter of the engaging member 26 is greater than the width of the chassis in which it is receiving such that the chassis does not slip off of the engaging member 26 when lifted. In one embodiment, the engaging member 26 comprises an arcuate platform for further grasping the chassis of a vehicle. The arcuate platform would further prevent the chassis of a vehicle from slipping therefrom. In a second embodiment, the engaging member 26 comprises raised ridges adapted to enhance the grip on the frame of a vehicle being raised by the jack. In another embodiment, the engaging member 26 comprises a plurality of raised protrusions adapted to enhance the grip of the platform.

In operation, when the hydraulic cylinder 12 is extended and retracted, the piston 55 and the engaging member 26 extend vertically through the first opening 22 of the upper wall 20. When the engaging member 26 is retracted such as to stow the hydraulic cylinder 12 inside the housing 10, the piston 55 retracts vertically through the first opening 22, which then receives the engaging member 26 when the piston 55 is fully retracted, such that the engaging member 26 rests flush thereto.

The base tube 50 further comprises an expandable chamber 65 therein, wherein the chamber 65 is configured to receive an approximately incompressible hydraulic fluid 75, such as oil. The chamber 65 is configured to be expandable by the hydraulic fluid 75, thereby driving the piston 55 therein in an upwards direction. The chamber 65 is coupled to a reservoir 70 in the electrically driven hydraulic pump 14 via a coupling valve 60. The reservoir 70 comprises the approximately incompressible hydraulic fluid 75. The hydraulic pump 14 comprises an electrical drive 80 configured to actuate the hydraulic pump 14, such that the hydraulic pump 14 displaces the hydraulic fluid 75 in a first direction from the reservoir 70 through the coupling valve 60 into the expandable chamber 65. The hydraulic pump 14 is further configured to drive the displaced hydraulic fluid 75 in a second direction back from the expandable chamber 65 through the coupling valve 60 and into the reservoir 70. The coupling valve 60 is configured to enable the hydraulic fluid 70 to flow in either the first or second direction.

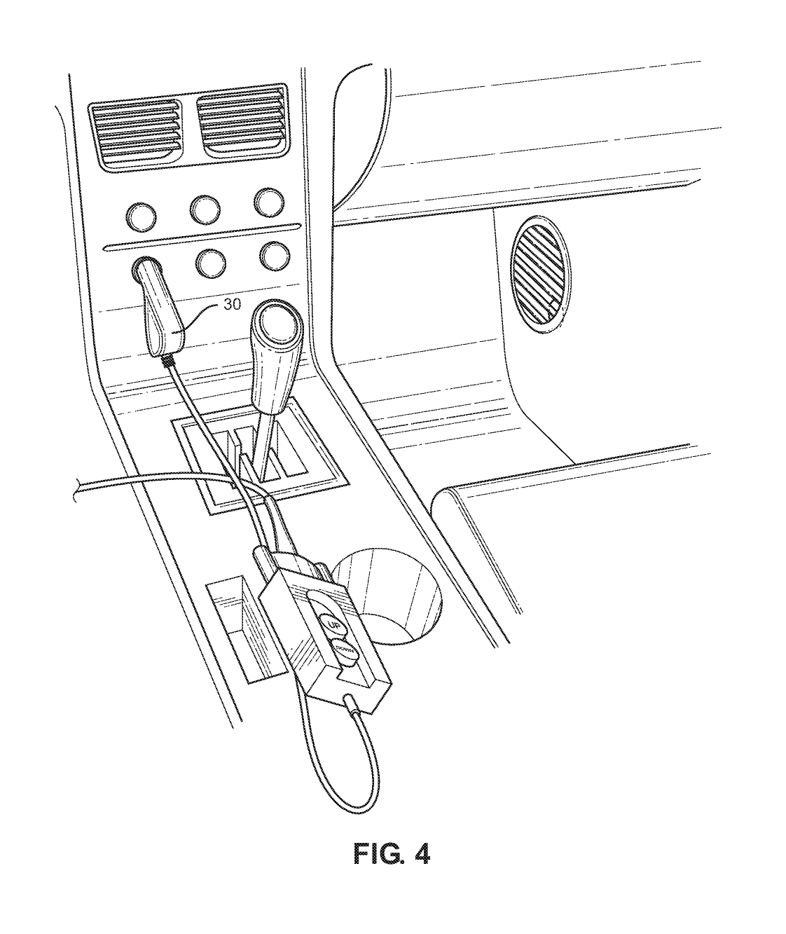

The hydraulic pump 14 is operably connected to a remote control 28 having a connector 30 configured to connect to a vehicle's power supply port to provide power to the hydraulic pump 14. The remote control 28 is disposed outside of the housing 10 and comprises one or more depressible switches for activating and driving the hydraulic pump 14. In the depicted embodiment, the remote control 28 has two depressible switches, an up switch 32A for driving the hydraulic fluid 75 in a first direction into the hydraulic cylinder 12 and a down switch 32B for driving the hydraulic fluid 75 back into the hydraulic pump 14. The remote control 28 comprises a first cable 34 at a first end which forms the connection between the remote control 28 and the hydraulic pump 14. The first cable runs through an aperture 36 disposed on the housing 10, which forms a channel through which the first cable 34 connects the hydraulic pump 14 to the remote control 28. The remote control 28 further comprises a second cable 38 at a second end which includes the connector 30. As shown by FIG. 4, the connector 30 preferably comprises a car power adapter configured to engage with a vehicle's cigarette lighter receptacle.

In operation, depression of the up switch 32A on the remote control 28 would actuate the electrical drive 80 of the hydraulic pump 14. The hydraulic pump 14 would then displace the hydraulic fluid 75 from the pump's reservoir 70 through the coupling valve 60 and into the expandable chamber 65. As the hydraulic fluid 75 is displaced from the pump's reservoir 70 and into the chamber 65, the volume of the chamber 65 is expanded, creating a pressure underneath the piston 55 that exerts an upward vertical force on the piston 55 that is stronger than the downward vertical force exerted by the piston 55. The piston 55 is thereby driven from the base tube 50 in an upwards vertical direction out of the first opening 22 of the housing 10 until the engaging member 26 receives and a lifts a vehicle. Once the up switch on the remote control 28 is let go, the hydraulic pump 14 ceases to displace the hydraulic fluid 75 into the chamber 65, thereby ceasing the elevation of the piston 55. Depression of the down switch 32B actuates the electrical drive 80 of the hydraulic pump 14 such that the hydraulic pump 14 transfers the hydraulic fluid 75 in the chamber 65 back into the pump's reservoir 70. This action reduces the volume of the chamber 65, thereby decreasing the pressure exerted on the piston 55, such that the upward vertical force exerted thereon is lesser than the downward force exerted by the piston 55. This action drives the piston 55 back into base tube 50 and the engaging member 26 back into the housing 10.

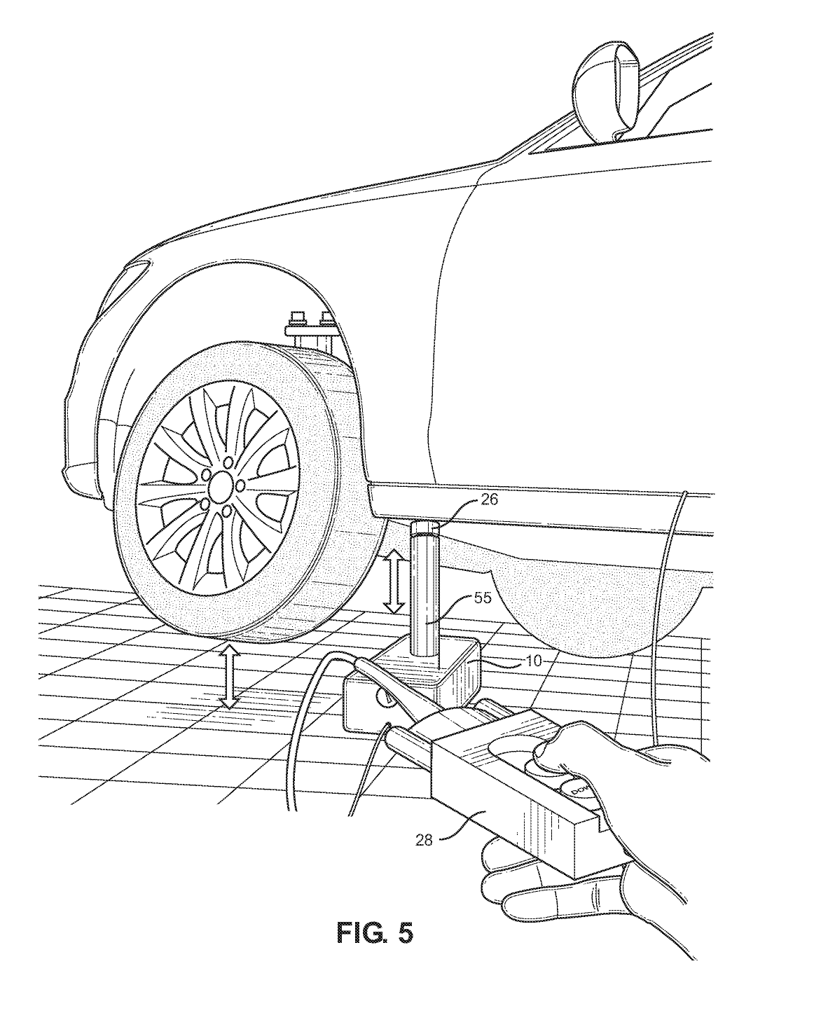

Referring now to FIG. 5, there is shown a perspective view of portable electronic vehicle jack in use according to one embodiment of the present invention. In the depicted embodiment, the remote control 28 comprises an up and a down switch for extending and retracting the hydraulic cylinder, respectively. In one use, a user would first position the vehicle jack adjacent to the tire and underneath the chassis of a vehicle, thereby aligning the engaging member 26 with the chassis such that it is in a position to engage the chassis and lift the vehicle when raised. Next, the user would plug in the connector into the cigarette liter receptacle of the vehicle to give the vehicle jack power. Next, a user would depress the up switch on the remote control 28 such that hydraulic pump is activated and the piston 55 extends out from the interior of the housing 10 such that it may lift the vehicle. A user would then depress the down switch such that the hydraulic pump is activated and the piston 55 retracts back into the housing 10 into is stowed configuration. Finally, the user would pick up the vehicle jack by its handle and transport the vehicle jack to the trunk for storage.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A portable electronic vehicle jack, comprising:
a housing;
a hydraulic pump positioned within said interior volume;
a hydraulic cylinder positioned within said interior volume, said hydraulic cylinder operably connected to said hydraulic pump;
a piston positioned in said hydraulic cylinder, said piston configured to extend and retract from said housing; and
a remote control operably connected to said hydraulic pump, said remote control being adapted to control the operation of said hydraulic pump.

2) The portable electronic vehicle jack of claim 1, further comprising an engaging member disposed at a distal end of said piston.

3) The portable electronic vehicle jack of claim 1, wherein said hydraulic pump further comprises a reservoir containing a hydraulic fluid therein.

4) The portable electronic vehicle jack of claim 1, further comprising a coupling valve, said coupling valve operably coupling said hydraulic cylinder to said hydraulic pump.

5) The electronic vehicle jack of claim 1, wherein said remote control further comprises an electric cable having a connector connectable to a vehicle's power supply port.

6) The portable electronic vehicle jack of claim 1, wherein said housing is composed of a durable plastic selected from the group consisting of polycarbonate, polyvinyl chloride, and polypropylene.

7) The portable electronic vehicle jack of claim 1, further comprising a handle hingedly connected to the exterior surface of a side wall of said housing.

8) The portable electronic vehicle jack of claim 5, wherein said connector of said electrical cable is adapted to engage with a vehicle's cigarette lighter receptacle.

9) The portable electronic vehicle jack of claim 2, wherein said engaging member rests flush with the exterior surface of an upper wall of said housing when retracted.

10) The portable electronic vehicle jack of claim 2, wherein said engaging member comprises a circular platform composed of a rubber material.

11) The portable electronic vehicle jack of claim 10, wherein said circular platform further comprises raised protrusions.

12) The portable electronic vehicle jack of claim 10, wherein said circular platform further comprises raised circular ridges.

13) A portable electronic vehicle jack, comprising:
a housing having an interior volume therein;
an upper wall disposed on said housing, said upper wall having a first opening;
a hydraulic cylinder disposed in said interior volume, said hydraulic cylinder comprising a base tube having an expandable chamber;
a piston slidably disposed within said base tube forming a telescopic arrangement therein;
wherein said piston is configured to extend and retract through said first opening of said housing;
an engaging member, said engaging member being disposed at a distal end of said piston;
wherein said engaging member is configured to sustain the chassis of a vehicle;
an electrically driven hydraulic pump, said hydraulic pump comprising a reservoir having a hydraulic fluid therein;
a coupling valve, said coupling valve operably coupling said reservoir of said hydraulic cylinder to said expandable chamber of said hydraulic pump;
wherein said hydraulic pump is configured to displace said hydraulic fluid via said coupling valve; and
a remote control operably connected to said hydraulic pump, said remote control comprising one or more switches configured to actuate said hydraulic pump; said remote control further comprising an electric cable;
wherein said electrical cable includes a connector connectable to a vehicle's cigarette lighter receptacle.

14) The portable electronic vehicle jack of claim 1, wherein said housing is composed of a plastic selected from the group consisting of polycarbonate, polyvinyl chloride, and polypropylene.

15) The portable electronic vehicle jack of claim 1, further comprising a handle hingedly connected to the exterior surface of a side wall of said housing.

16) The portable electronic vehicle jack of claim 1, wherein said engaging member is configured to rest flush to the exterior surface of said upper wall of said housing when retracted.

17) The portable electronic vehicle jack of claim 1, wherein said engaging member comprises a circular platform composed of a rubber material.

18) The portable electronic vehicle jack of claim 17, wherein said circular platform further comprises raised protrusions.

19) The portable electronic vehicle jack of claim 17, wherein said circular platform further comprises raised circular ridges adapted to grip a load.
